(19) United States
(12) Patent Application Publication
(10) Pub. No.: US 2005/0253838 A1
(43) Pub. Date: Nov. 17, 2005

(54) Key-frame processor for computer system

(76) Inventors: Shin-Hung Chang, Taipei City (TW); Shao-Ting Lee, Taipei City (TW); Jan-Ming Ho, Taipei City (TW)

Correspondence Address: TRANSPACIFIC LAW GROUP, 617 NORTH DELAWARE STREET, SAN MATEO, CA, 94401, US

(21) Appl. No.: 10/847,051

(22) Filed: May 16, 2004

(51) Int. Cl. G09B 13/00; G06T 1/00; G09B 3/00

(52) U.S. Cl. 345/418; 434/350

(57) ABSTRACT

A key-frame processor for computer system is provided to couple with the streaming server of the computer system to transmit a series of continuous computer image frames to a plurality of user sites. The key-frame processor for computer system comprises a key-frame reconstruction module and a key-frame selective streaming module. The key-frame reconstruction module is coupled with an instructor computer system to obtain image data transmitted by the instructor computer system to the streaming server, which image data represent image being displayed at the instructor computer. The key-frame reconstruction module reconstructs the obtained image data into displaying data representing the whole image as displayed, maintains data of the whole image being currently displayed at the instructor computer from time to time and stores the whole image data at the streaming server regularly. The key-frame selective streaming module is coupled with the streaming server and, under certain conditions, grabs data of the currently displayed whole image as stored by the key-frame reconstruction module as key-frame to be transmitted. The instructor computer system needs not to conduct key-frame processing, such that operation of the instructor computer system is made smooth.

### FIELD OF THE INVENTION

The present invention relates to a key-frame processor for computer system, especially to image data processing device used in the computer system to avoid instantaneously system workload for the sack of capturing full screen to generate key-frame.

### BACKGROUND OF THE INVENTION

Along with the development of the distance learning service, more and more people access to higher education through such distance learning system. Thanks to the advances of broadband network system and data compression technology, it is now possible to provide real-time broadcast service for data streams in a computer system for purpose of distance learning, whereby images are displayed directly or on demand.

In the conventional distance learning system, images of instructor's computer display viewed by users are those taken from instructor's computer display by using a video camera, then processed and broadcast these video data to user site computer for display. Due to the low resolution of the video camera, when the image as displayed on the display of the instructor computer are displayed on the display of a user site computer, the image becomes blurred. As a result, the remote users are not able to perceive content that the instructor intends to show to the users. In order to overcome this problem, a real-time computer screen grabber is developed to grab data representing the images to be displayed on the display of the instructor computer system and to broadcast the grabbed images to user site computers. Under this approach, full motions on the instructor's computer will be presented on remote user computers.

It has been found that, while operating a computer system, not every part of the displayed image on the computer screen changes from time to time. It often happens that only a few portions or sections of the image as displayed are changed. In order to enhance the broadcasting quality and to increase the streaming of the displayed images, only the differences between two consecutive images are transmitted. In the user site, full motions on instructor's computer will be represented by inserting differences to the previous image to obtain the current image. The current image may thus be displayed in the user site computer correctly.

The above method is useful in the case of broadcasting a continuous series of image. When broadcasting such series, data of the whole image frame are transmitted only at the stage of the first image. For the rest images, only the differences are transmitted. Since the images are in series, all these images may be resumed correctly. However, it is not feasible to apply this method to the distance learning system. A major reason is the fact that not every user starts to receive the image data from the first image frame. If a user starts to receive the image from a frame other than the first, only fragment images will be displayed. In addition, when replaying the images off-line, no matter where the starting point is, the user site computer needs to decode the image from the ever first image up to the current image. Otherwise a fragment images will be displayed.

In order to solve this problem, the conventional art provided a technology of composing key-frames periodically while streaming media. The term “key-frame” denotes to the whole image of a computer display. In using the key-frame technology in the broadcast, key-frames are composed and added to the image frame data to be transmitted only under certain conditions at regular or irregular intervals. As a result, no matter when a user site computer starts to receive the program, data of a whole image frame will be accessible upon or soon after user's starting to receive. Similarly, in the case of replaying off-line, the user site computer may start its decoding process from the most recent key-frame, instead of from the ever first frame.

Such a method may not only be used in the real-time broadcasting, distance learning system, it may be used in the recording system of computer graphics. In other words, when a program is being recorded, the computer system may, at regular intervals, obtain data of a whole image frame and store them into the program as recorded. No matter where of the program the user starts to view the program, a whole image may be easily obtained within a very short time.

However, in the conventional key-frame transmission technologies, processing of the key-frame data is conducted in the computer equipment at the instructor site. As a result, an instantaneous system workload (such as high CPU utilization, system bus utilization and network bandwidth) will take place in the instructor computer when the key-frame data processing is conducted.

When the instructor computer is occupied by the key-frame data processing, only a few capacities are left for the operation of the instructor's demonstration, making the demonstration slow, or even difficult. In order to allow the instructor site computer to display continuous and whole screens of the demonstration, all key-frame image data are all transmitted to the streaming server upon their generation, such that the streaming server transmits these data to all user site computers. Such approach, however, brings up another problem. That is, an instantaneous workload is brought to the network communication system. This does not only make management of the network system difficult but also damage the displaying quality at the user site.

### OBJECTIVES OF THE INVENTION

The objective of this invention is to provide a novel key-frame processor for computer system to effectively avoid instantaneous workload of the computer system as well as the network system.

Another objective of this invention is to provide a key-frame processor for computer system to regulate transmission of key-frame data in order to reduce frequency of key-frame data transmission.

Another objective of this invention is to provide a key-frame obtaining and transmission control device for computer system to enable transmission of key-frame data to user sites at optimal time points.

According to this invention, a key-frame processor for computer system is provided. The key-frame processor for computer system of this invention is provided to couple with the streaming server of the computer system to transmit a series of continuous display image frames to a plurality of user sites. The key-frame processor for computer system comprises a key-frame reconstruction module and a key-frame selective streaming module. The key-frame reconstruction module is coupled with an instructor computer system to obtain image data transmitted by the instructor computer system to the streaming server, which image data represent image being displayed at the instructor computer. The key-frame reconstruction module reconstructs the obtained image data into displaying data representing the whole image as displayed, maintains data of the whole image being currently displayed at the instructor computer from time to time and stores the whole image data at the streaming server regularly. The key-frame selective streaming module is coupled with the streaming server and, under certain conditions, grabs data of the currently displayed whole image as stored by the key-frame reconstruction module as key-frame to be transmitted. The instructor computer system needs not to conduct key-frame processing, such that operation of the instructor computer system is made smooth.

These and other objectives and advantages of this invention may be clearly understood from the detailed description by referring to the following drawings.

### BRIEF DESCRIPTION OF THE DRAWINGS

FIG. 1 illustrates the systematic diagram of the key-frame processor for computer system of this invention.

FIG. 2 shows the flowchart of the operation of the key-frame processor for computer system of this invention.

### DETAILED DESCRIPTION OF THE INVENTION

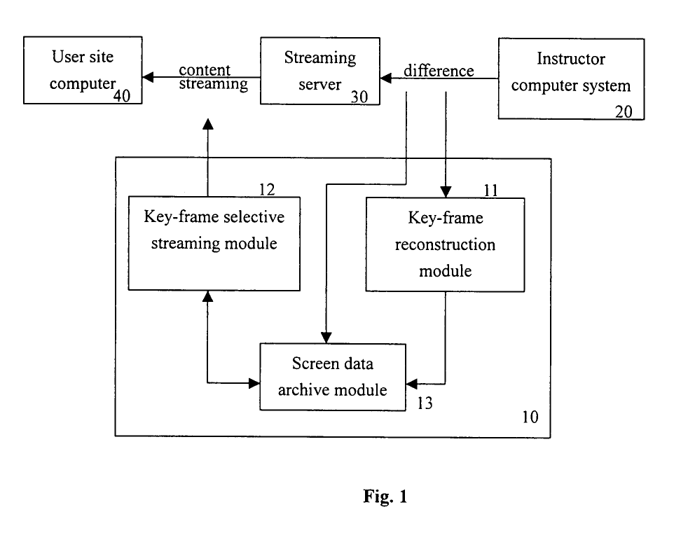

The embodiment of the key-frame processor of this invention will be described in the followings. FIG. 1 illustrates the systematic diagram of the key-frame processor for computer system 10 of this invention. As shown in this figure, the key-frame processor for computer system is provided to couple with the streaming server 30 of the computer system to transmit a series of continuous displaying image frames to a plurality of user sites 40. The key-frame processor for computer system 10 comprises a key-frame reconstruction module 11 and a key-frame selective streaming module 12.

The key-frame reconstruction module 11 is coupled with an instructor computer system 20 to obtain image data transmitted by the instructor computer system 20 to the streaming server 30, which image data represent image being displayed at the instructor computer 20. The key-frame reconstruction module 11 reconstructs the obtained image data into displaying data representing the whole image as displayed, maintains data of the whole image being currently displayed at the instructor computer 20 from time to time and stores the whole image data at the frame archive module 13 regularly. The key-frame selective streaming module 12 is coupled with the streaming server 30 and, under certain conditions, grabs data of the currently displayed whole image as stored at the frame archive module 13 by the key-frame reconstruction module 11 as key-frame to be transmitted.

Also as shown in FIG. 1, the screen displays of the instructor computer system 20 are continuously transmitted to the streaming server 30. The transmitted data, however, are data representing differences between consequential screen images, i.e., the difference between a screen image and its previous screen image. The instructor computer system 20 needs not to process and to transmit the key-frame from time to time. The data that streaming server 30 transmits (broadcasts) to the plurality of user site computers 40 are also those representing differences between consequential screen images.

Image data grabbed by the key-frame reconstruction module 11 during the transmission of the instructor computer system 20 are differential data of screen display. However, since the key-frame reconstruction module 11 obtains the image data from the instructor site computer system 20, image data as stored by the key-frame reconstruction module 11 represent the current key-frame at all times. In other words, the image data stored by the key-frame reconstruction module at the frame archive module 13 represent the whole screen display of the instructor computer system 20.

In another embodiment of this invention, the key-frame reconstruction module 11 obtains the screen display of the instructor computer system 20 directly and maintains at all times data of the whole screen display of the instructor computer 20 and stores the data regularly. However, due to the fact that the data transmitted by the instructor computer system 20 to the streaming server 30 are sufficient for the key-frame reconstruction module 11 to reconstruct the whole image of the screen display of the instructor computer system 20, it is preferable to reconstruct the key-frame image data, since such processing requires less computer resources.

In the application of this invention, the key-frame reconstruction module 11 may update the key-frame data at an interval of about 5 seconds. Under the same frequency, the conventional technology consumes approximately 50% of the computer resources to maintain the key-frame data and a workload bursty takes place regularly each 5 seconds. When using the key-frame processor for computer system of this invention, only about 30% of the computer resources is needed to maintain the key-frame data and no workload bursty will happen. Of course, the key-frame data may be updated in other frequencies. The frequency of the update operation depends on the consuming rate of the computer system and the given waiting time at a newly jointed user site before a whole picture is received. It is not any technical limitation to the present invention.

In the embodiment of this invention, the key-frame selective streaming module 12 obtains the key-frame data stored in the frame archive module 13 and transmits such data to user sites under particular conditions, such as when a user site computer 40 makes such request, when a newly logged-in user is identified, or when an incident, e.g. a sudden decay in the quality of the network communication, is sensed. In addition, it is possible to establish other conditions at which the key-frame streaming module 12 obtains and transmits the key-frame image data.

Since the key-frame image data are transmitted only under particular conditions, and are transmitted to selected user sites, frequency of key-frame transmission may be effectively reduced. Since the key-frame image data are transmitted to selected user sites only, the transmission may be conducted at optimal time points and to most necessary users. Instantaneous workload in the instructor computer system 20 as well in the network communication system may thus be avoided.

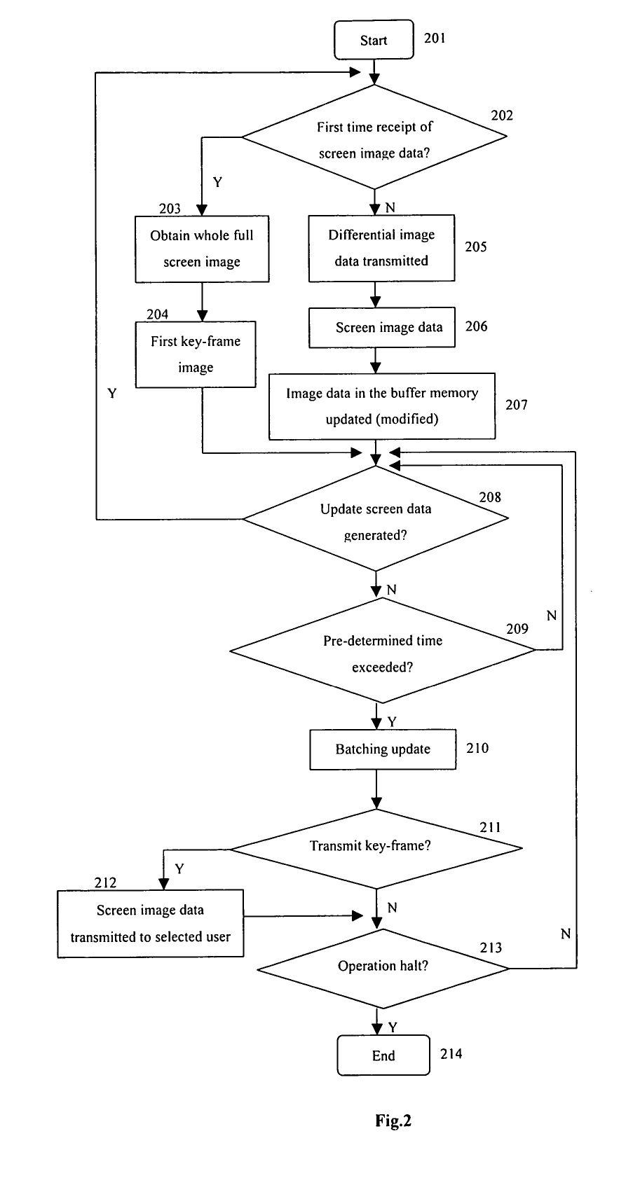

The following is a description of the operational flow of the key-frame processor for computer system of this invention. FIG. 2 shows the flowchart of the operation of the key-frame processor for computer system of this invention.

As shown in FIG. 2, at 201 the instructor computer system 20 transmits to the streaming server 30 image data of its screen display and such operation is sensed by the key-frame reconstruction module 11 of this invention. At 202 the key-frame reconstruction module 11 determines whether this is the first time it receives image data from the instructor computer system 20. If yes, the whole image of the instructor computer system's screen display is obtained at 203 and stored at the frame archive module 13 at 204. Otherwise, the differential image data transmitted by the instructor computer system 20 is obtained at 205. At 206 the image data as stored in the frame archive module 13 is obtained and stored in a buffer memory (not shown). At 207 the image data in the buffer memory is updated (modified) using the differential image data. At 208 the key-frame reconstruction module 11 determined whether update data are generated by the instructor computer system 20. If yes, the operation returns to step 202; otherwise the key-frame reconstruction module 11 determines whether the time lag between such new update and the last update of the key-frame image data in the frame archive module 13 exceeds a predetermined time at 209. If not, the operation returns to step 208; otherwise the key-frame image data in the frame archive module 13 is updated by replacing the image data in the buffer memory at 210. At 211 the key-frame selective streaming module 12 determines whether a condition for transmitting key-frame data is satisfied. If yes, the key-frame image data in the frame archive module 13 is transmitted to selected user sites at 212; otherwise, it determines whether the operation of the instructor computer system 20 is halted at 213. If no, the operation returns to step 208; otherwise the operation ends at 214.

The instructor computer system needs not to conduct key-frame processing, such that operation of the instructor computer system is made smooth.

As described above, the key-frame processor for computer system of this invention uses the differential image data generated by the instructor computer system to reconstruct the key-frame image at the streaming server. Regular or irregular grabbing of key-frame image data from the instructor computer system may thus be reduced. The key-frame image data are transmitted to the user sites under certain conditions. Regular broadcast of key-frame image data to a large number of users is thus avoided.

As the present invention has been shown and described with reference to preferred embodiments thereof, those skilled in the art will recognize that the above and other changes may be made therein without departing form the spirit and scope of the invention.

1. A key-frame processor for computer system to couple with the streaming server of a computer system comprising an instructor computer and a streaming server coupled to said instructor computer to transmit a series of continuous computer display images to a plurality of user sites, comprising:
a key-frame reconstruction module coupled with said instructor computer to obtain image data transmitted by said instructor computer system to said streaming server, which image data represent image being displayed at screen of said instructor computer and to maintain data of whole image being currently displayed at screen of said instructor computer from time to time and stores said whole image data at the streaming server regularly; and
a key-frame selective streaming module coupled with said streaming server to obtain and to transmit, under certain conditions, data of said currently displayed whole image as key-frame data.

2. The key-frame processor for computer system according to claim 1, wherein said image data obtained by said key-frame reconstruction module from said instructor computer are differential data of screen displays.

3. The key-frame processor for computer system according to claim 1, wherein said image data obtained by said key-frame reconstruction module from said instructor computer are data of whole screen display.

4. The key-frame processor for computer system according to claim 1, wherein said key-frame selective streaming module transmits said key-frame image data to selected user sites.

5. The key-frame processor for computer system according to claim 1, wherein said key-frame selective streaming module transmits said key-frame image data upon requests by users.

6. The key-frame processor for computer system according to claim 1, wherein said key-frame selective streaming module transmits said key-frame image data when a new user is identified.

7. The key-frame processor for computer system according to claim 1, wherein said key-frame selective streaming module transmits said key-frame image data when decay of quality of network communication is identified.
